(19) United States
(12) Patent Application Publication
(10) Pub. No.: US 2007/0090081 A1
(43) Pub. Date: Apr. 26, 2007

(54) Flexible drinking lid

(76) Inventors: Dylan Briscoe, Barrie (CA); Amy Briscoe, Barrie (CA)

Correspondence Address: D.W. EGGINS, 18 DOWNSVIEW DRIVE, BARRIE, ON, L4M 4P8, CA

(21) Appl. No.: 11/257,052

(22) Filed: Oct. 25, 2005

(51) Int. Cl. B65D 51/16; A61J 9/00; B65D 83/00; A47G 19/22

(52) U.S. Cl. 215/307; 220/717; 215/11.4; 215/387

(57) ABSTRACT

An elastic lid for application in closing relation with various beverage containers is of silicone rubber, with a resilient, stretchable diaphragm-cover portion with a down-turned rim, which enables its use with a range of sizes of containers. The rim has peripheral sealing ribs, and includes pull-tabs, to facilitate installation/removal. The lid has an upstanding mouthpiece located adjacent its rim, with a few, restricted apertures which limit the beverage drinking or spillage rate. An oppositely-located air vent hole may be provided; also the cover surface may be ribbed. The slim profile and flexible nature of the subject lid suits it for being carried in pocket or purse, within a protective envelope.

### CROSS REFERENCE TO RELATED APPLICATIONS

Not Applicable (N/A)

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

This invention is directed to a flexible lid with a drinking spout, that can be fitted to containers having a range of brim diameters, and is readily carried in pocket or purse.

2. In the past children's cups have been provided having rigid removable covers that incorporate a moulded perforated mouthpiece from which a user can drink.

Such cups are somewhat bulky, and are unsuited for use in restaurants and the like, where a child may be served a beverage in a possible varying size of container ranging from beverage (soft-drink) cans to juice glasses in a range of sizes. In such instances, it is not convenient to provide and use a child's drinking cup, which would require the transfer of the beverage from its as-served container into the drinking cup, with the possibility of spillage, particularly when an aerated drink is involved that is highly likely to foam-up and overfill the cup into which it is being poured.

### BRIEF SUMMARY OF THE INVENTION

The present invention provides a lid suitable for application in sealing relation to a range of different sized beverage containers. The lid has a resilient, stretchable diaphragm-cover portion with a down-turned rim, which can be applied in enclosing relation to a predetermined range of sizes of containers, by virtue of its stretchable nature. The lid has an upstanding moulded mouthpiece located adjacent its rim, through which a limited flow of beverage can be drunk. An air vent hole may be provided, located diametrically opposite the mouthpiece. One or more tabs extend from the edge of the rim, to facilitate application and removal of the lid from a container.

The top surface of the lid may have one or more raised ribs, for purposes of appearances, stabilization, and production. These ribs may be arranged concentrically or otherwise.

The lid may be of silicone material such as a rubber to provide the required elastic and hygienic characteristics.

The slim profile and flexible nature of the subject lid suits it for being carried in ones pocket or purse, wrapped in a protective envelope.

The lid is well-suited for use in automobiles, with implications of enhanced safety, it being less susceptible to significant spillage if dropped or turned over; the silicone material also being substantially insensitive to hot beverages such as coffee.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a perspective view from above of a rib-less embodiment of a stretchable drinking lid in accordance with the present invention;

FIG. 2 is a plan view of the FIG. 1 embodiment;

FIG. 3 is a side view of the FIG. 1 embodiment;

FIG. 4 is a diametrical cross-section taken through the spout of FIGS. 1 and 2;

FIG. 5 is a plan view of a second, reversed embodiment including a showing of concentric ribs;

FIG. 6 is a plan view of a second ribbed embodiment with radiating ribs and a vent; and,

FIG. 7 is a general view showing the subject stretchable lid mounted upon a glass.

### DETAILED DESCRIPTION OF THE INVENTION

It will be understood by those skilled in the art that the above disclosure is directed primarily to specific embodiments of the present invention, and that the subject invention is susceptible of reduction to practice in other embodiments that fall within the scope of the appended claims.

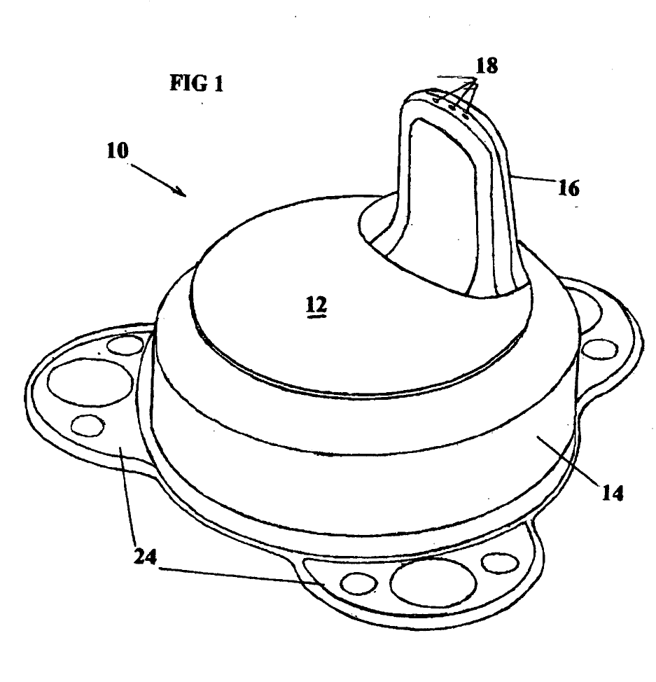

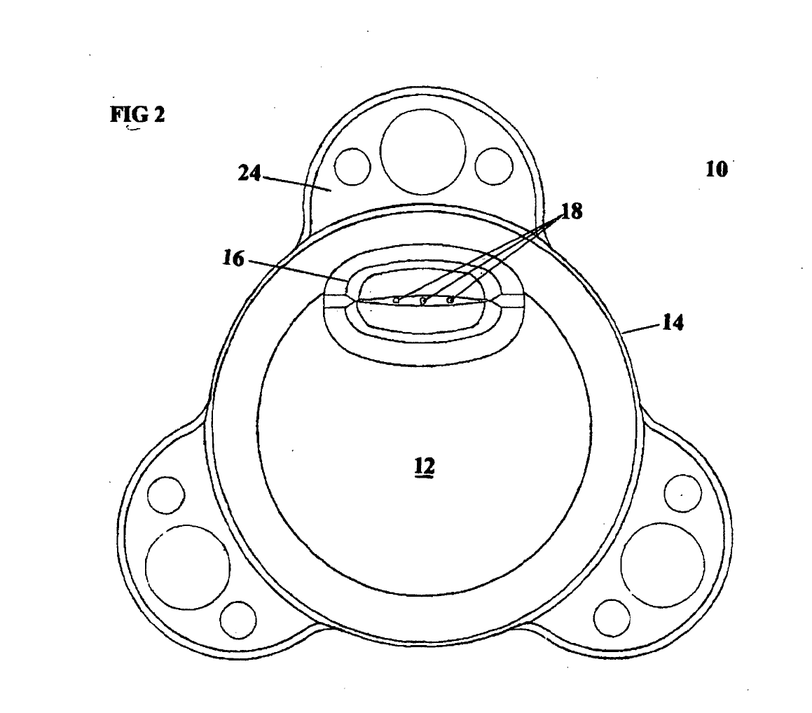

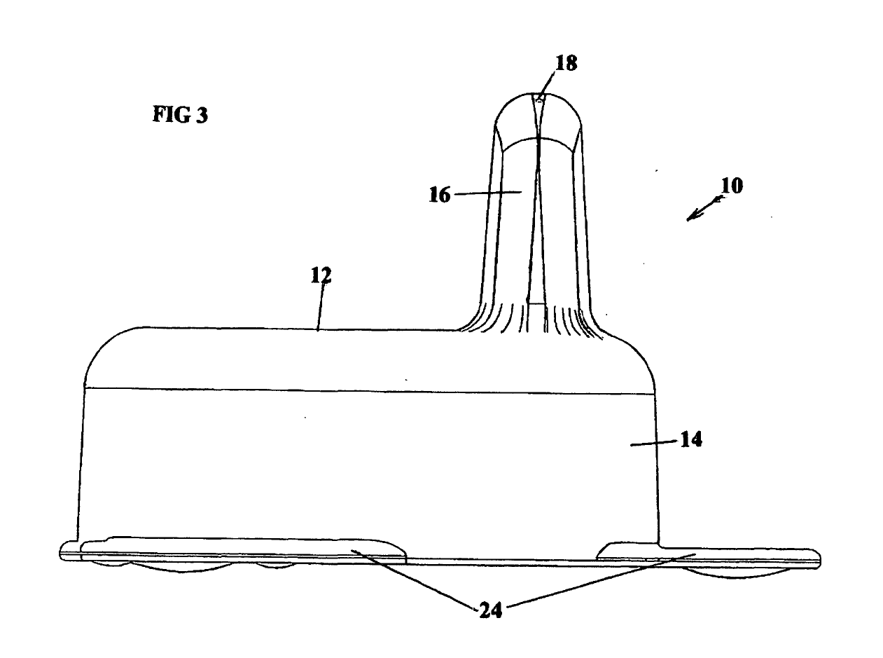

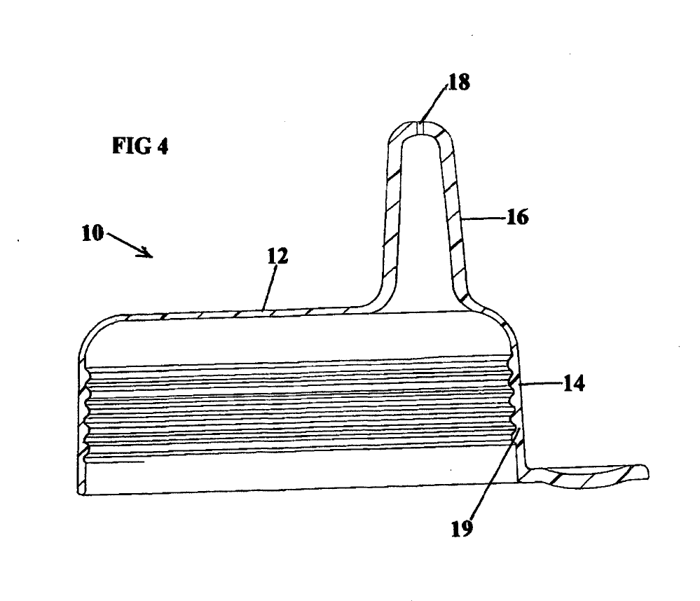

Referring to FIGS. 1, 2 and 3, lid embodiments 10 in accordance with the present invention have a substantially planar upper surface 12 and a depending rim portion 14. A moulded mouthpiece 16 located adjacent the rim portion 14 has a plurality of through passages 18 (see also FIG. 4) to provide a controlled rate of flow through the mouthpiece 16.

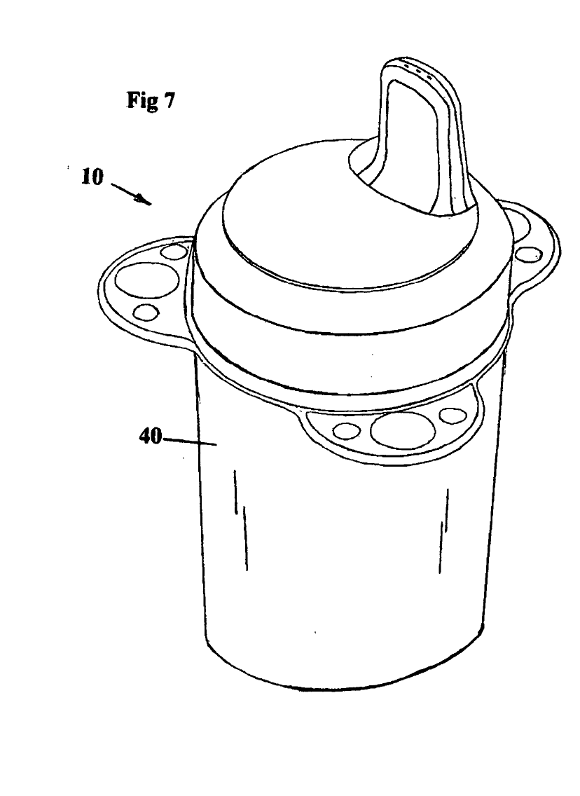

A plurality of annular ribs 19 are located on the interior of the rim portion 14, to promote both grip and sealing of the cover 10, when applied to a drinking vessel. The lid 10 is illustrated as having three projecting pull tabs 24 to facilitate the application and removal of the lid 10 from a glass or other container such as container 40 (see FIG. 7). Owing to the soft nature of the silicone material used, the tabs 24 tend to droop, and to readily conform on contact with a user.

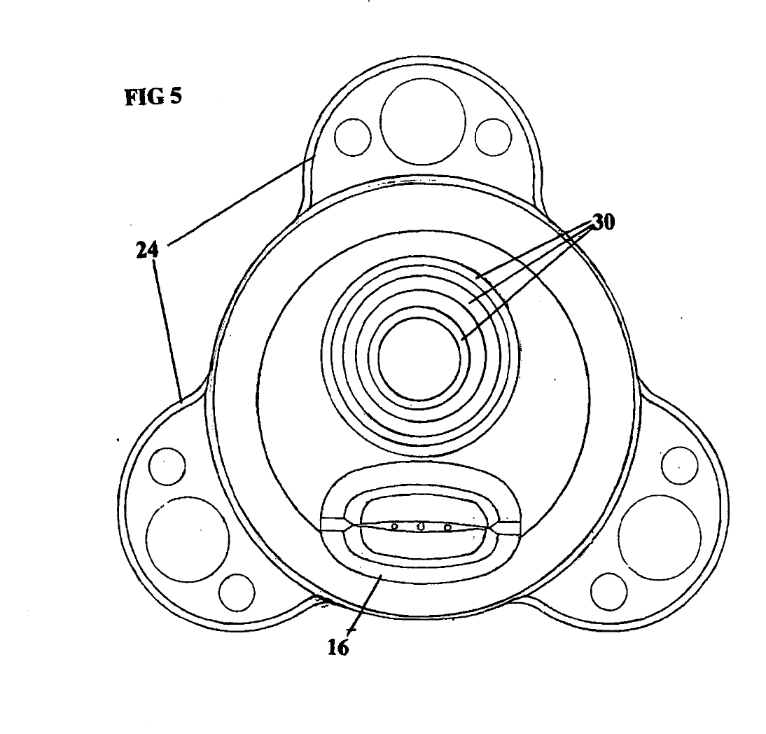

Referring to FIG. 5, the mouthpiece 16 is illustrated as being located between two of the pull tabs 24, and diametrically opposite the third pull tab 24. Also shown are a plurality of ribs 30 which occupy and strengthen the upper surface of the lid 10.

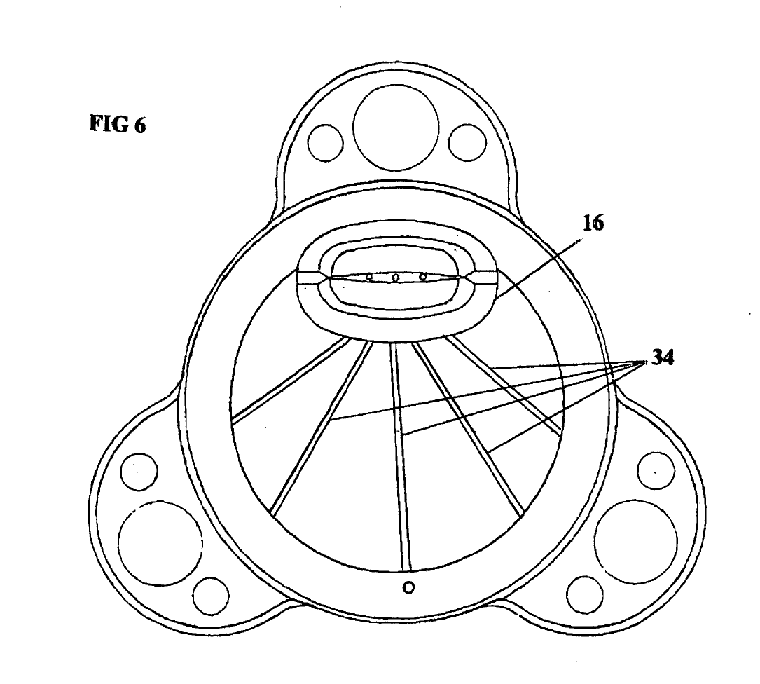

In FIG. 6, ribs 34 radiate from the mouthpiece 16. Also in FIG. 6, an air-bleed aperture 36 is shown, located substantially diametrically opposite the mouthpiece 16 and inboard of rim portion 14 a distance sufficient to ensure access to the interior of a container 40, as shown in FIG. 7.

It has been found that three flow passages 18, of 0.75 mm (0.03 inch) diameter give adequate flow rates for water and liquids of like viscosity and surface tension, while also suffering minimal leakage when dropped.

In one embodiment, a lid having an unstressed diameter of 70 mm (2.75 inches) was used effectively with beverage containers ranging in diameter from 72 mm (2.83 inches) to 84 mm (3.3 inches), representing a 20% stretch.

A safe stretch capacity in the range from 35 to as high as 50 percent is anticipated. When packaged in bulk, the subject lids are preferably separated by the insertion of a ‘slip’ sheet, to prevent untoward nesting, and difficulty in separating.

1. A lid suitable for application in sealing relation to beverage containers in a predetermined range of sizes, the lid having a resilient, stretchable diaphragm-cover portion with a down-turned rim, for application across the mouth of a said container in enclosing relation therewith, and having a projecting mouthpiece located adjacent its rim, through which a flow of beverage can be drunk.

2. The lid as set forth in claim 1, wherein said cover portion is substantially circular.

3. The lid as set forth in claim 1, said mouthpiece being upstanding and having a plurality of small apertures therethrough, to limit the rate of passage of said beverage through said mouthpiece.

4. The lid as set forth in claim 2, including an air vent hole located substantially diametrically opposite from said mouthpiece.

5. The lid as set forth in claim 1, said downturned rim including at least one tab portion extending from the rim to facilitate application and removal of the lid from said container.

6. The lid as set forth in claim 5, having a plurality of said tab portions in mutually spaced relation about said lid.

7. The lid as set forth in claim 1, said cover portion having a top surface with at least one raised rib thereon.

8. The lid as set forth in claim 7, having a plurality of said raised ribs arranged in substantially concentric mutually spaced relation thereon.

9. The lid as set forth in claim 7 having a plurality of said ribs radiating from said mouthpiece.

10. The lid as set forth in claim 1, being of silicone rubber.

11. The lid as set forth in claim 1, being elastically flexible and readily deformable.

12. The lid as set forth in claim 1, being stretchable to an increase in diameter of about 20% from its original, unstretched diameter.

13. The lid as set forth in claim 1, being stretchable to an increase in diameter in the range of about 30 to 50% from its original, unstretched diameter.
